(19) United States
(12) Patent Application Publication
(10) Pub. No.: US 2010/0207359 A1
(43) Pub. Date: Aug. 19, 2010

(54) BICYCLE TRAILER CONVERTABLE TO WHEELBARROW

(76) Inventor: Mike Staniszewski, Mississauga (CA)

Correspondence Address: NASSER ASHGRIZ, 7805 Bayview Ave., # 1510, Thornhill, ON, L3T 7N1, CA

(21) Appl. No.: 12/370,649

(22) Filed: Feb. 13, 2009

(51) Int. Cl. B60D 1/00

(52) U.S. Cl. 280/504; 280/400

(57) ABSTRACT

A versatile bicycle trailer that turns into a wheel barrow is disclosed. This trailer comprises of a single wheel which follows directly inline with the bicycle tires and sustains a low centre of gravity, maneuvering easily around sharp turns and corners. The trailer has handles which are in closed position when the trailer is connected to a bicycle. The handles open when the trailer is not connected to the bicycle, therefore, allowing the trailer to be used as a wheelbarrow to carry cargo. Special kickstand holds the bicycle standing upright for easy loading and unloading of cargo.

### FIELD OF THE INVENTION

The present invention is a small, light weight, single wheel trailer that turns into a wheelbarrow, thus providing flexibility in carrying cargo.

### BACKGROUND OF THE INVENTION

Increase in health awareness, overcoming heavy traffic jams, environmentally friendliness, and increase in gas prices has resulted in a significant increase in bicycle usage. Unlike automobiles and motorbikes, bicycles are economical and cheap to maintain. However, one of the major drawbacks of bicycles is their limited ability to carry extra load or cargo other than the rider. Typically, simple bicycle baskets are used to carry cargo, however, their use is limited to small loads. A back-pack is also used by the rider to carry certain amount of load or cargo, however, it is very difficult to fetch the load and simultaneously peddle the bicycle. A simple way to carry a cargo on a bicycle is by using a trailer. Trailers can be attached to the rear end of a bicycle. A bicycle trailer has to be light weight, easy to connect and disconnect, and should not alter the bicycle balance.

Bicycle trailers can be categorized into two wheeled and single-wheeled trailers. Two wheeled trailers are used for relatively large and heavy loads. Most two wheeled trailers are designed such that most of the load is on the trailer wheels. For instance, U.S. Pat. No. 3,877,723, issued to Fahey, discloses a two wheeled bicycle trailer which comprises of a T shaped fixture supporting a wire basket to carry cargo. The basket is located away from the bicycle so that most of the load is put on the trailer wheels. Similarly, U.S. Pat. No. 5,020,813, issued to Gottschalk, discloses a two wheeled trailer for carrying people or small cargo, which is designed to provide stability to the bicycle. In this case, the trailer is so closely positioned to the bicycle that the combined system behaves like a tricycle. Similar two wheeled trailers are disclosed in U.S. Pat. Nos. 4,077,646, 4,381,117, 4,037,853, 4,077,645, 4,342,467, 3,829,125, 730,193.

One of the disadvantages of two wheeled trailers is that they do not align properly with the wheels of the bicycle, resulting in loss of maneuverability. The bicycle movement becomes limited to the movement of the trailer. For instance, if the bicycle leans over to one side while going around a bend, there is a probability that the cyclist loses the control of the bicycle because of the heaviness or the rigidity of the trailer. Also, if the trailer hits a bump or a pothole in the road, its sudden movement may cause lose balance by the bicycle rider.

The next group of bicycle trailers are single wheeled trailers, such as those disclosed in U.S. Pat. Nos. 660,598, 4,756,541, 5,011,170, 5,076,600, 5,171,034 and 5,641,173. One of the disadvantages of the previous designs has been high center of gravity of the trailer. Although, this has been recognized as being one of the important design issues, most trailers still have high center of gravity, and therefore, less stable. Another issue that most bicycle trailers have is the difficulty in connecting and disconnecting the trailer from the bicycle. The connection mechanism between the bicycle and trailer should be easy, stable, and flexible enough to allow for proper trailer motion behind the bicycle. The prior art describes a number of methods for attaching a trailer to the bicycle, mainly by using a hitch assembly. One of the problems with most bicycle hitch assemblies is that they may result in flipping of the trailer. Another problem with most bicycle hitch assemblies is that they attach under the seat of the bicycle. This makes the bicycle more unstable. Small oscillations in the trailer, translates directly to the bicycle seat, making the bicycle oscillate and go out of control.

Another issue in design of bicycle trailers, is the method of connection between the bicycle and the trailer. The method of connection dictates not only the stability of the bicycle, but also jerky movement of the trailer and the potential for tipping of the trailer when the bicycle would fall.

None of the prior art disclosing a trailer that converts into a wheelbarrow and can be used to carry cargo without the bicycle.

The present invention provides a hitch assembly which is easy to use and connects to the bicycle rear wheel axel. This results in better bicycle maneuverability and does not hinder the balance of the bicycle. The bicycle trailer described in this invention can be used for shopping or visiting a grocery store etc. The present bicycle trailer can be easily removed and converted into a wheelbarrow, and therefore be used inside grocery stores and shopping malls.

### SUMMARY OF THE INVENTION

The object of present invention is to provide an improved small size, light weight trailer particularly for bicycles. Another object of present invention is to provide a trailer which can be easily converted into a wheelbarrow for further transportation. Another object of the present invention is a trailer than can be converted to a wheelbarrow without any modifications of the existing trailer. Said wheelbarrow comprising of handles which allows the wheel barrow to move around. Another object of present invention is to provide a trailer that allows the bicycle to maneuver easily around sharp turns and corners and generally do not disturb the bicycle functionality. A further object of the present invention is to have a trailer which follows in line with bicycle wheels. Another object of the present invention is a bicycle trailer which can easily attach to and detach from the bicycle, without a need to have any instruments. Another object of the present invention is having a kick off stand (kickstand) under the trailer wheelbarrow, which allows for the trailer/wheelbarrow to stand by itself, when detached from the bicycle. The kick stand also holds the bicycle upright; no extra stand is required for the bicycle. Another object of present invention is novel hitch which can be removed and fixed very easily during the attachment and removal of the bicycle with trailer. Another object of present invention is to provide a trailer that can be attached to various bicycle wheel sizes: 26″ and above.

The main features of the present trailer are the followings: Transforms into a wheel barrow for further transportation; maneuvers easily around sharp turns and corners; follows bicycle in-line with bicycle wheels; attaches to a bicycle via quick release or specially designed nut sets; detaches from bicycle quickly and easily; trailer kickstand holds bicycle upright; fits most bicycles with 26″+size wheels; carries up to 30 kgs (66 lbs); and weighs about 5.8 kg (12.8 lbs).

These and other objects of the present invention will become readily apparent upon further review of the following specification and drawings.

### BRIEF DESCRIPTION OF THE DRAWINGS

In the figures, which illustrate, by way of example only, embodiments of the present invention,

FIG. 1 illustrates the trailer of the present invention in connection with a bicycle rear wheel in standing mode;

FIG. 2 illustrates the main components of the trailer;

FIG. 3 illustrates the top and the side views of the trailer body;

FIG. 4 illustrates wheelbarrow handles in closed and open modes, and the trailer in the wheelbarrow mode;

FIG. 5 illustrates the connecting means to connect the trailer to the bicycle;

FIG. 6 illustrates the methods of connecting the trailer fork to the bicycle wheel axel;

FIG. 7 illustrates the attaching means and the method of attaching the trailer body to the fork;

FIG. 8 illustrates the securing means for the trailer-fork attachment; and

FIG. 9 illustrates the dimensions of the one embodiment of the present trailer.

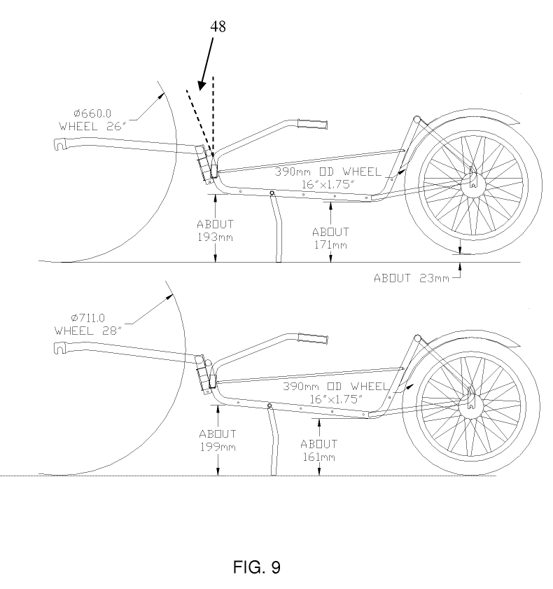

### DETAILED DESCRIPTION OF THE INVENTION

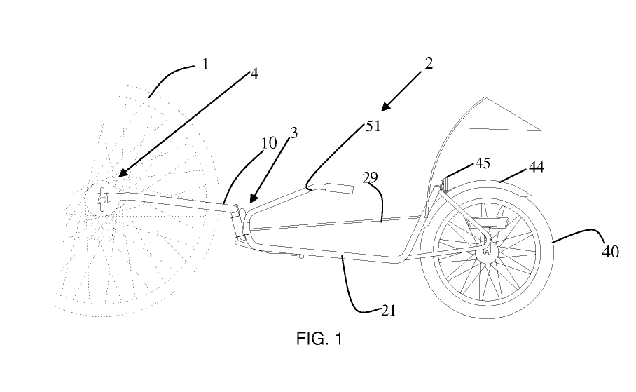

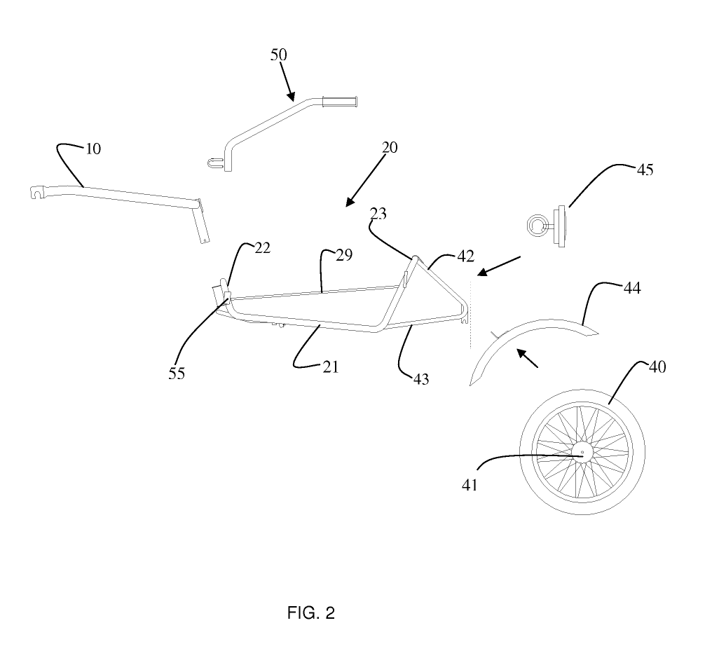

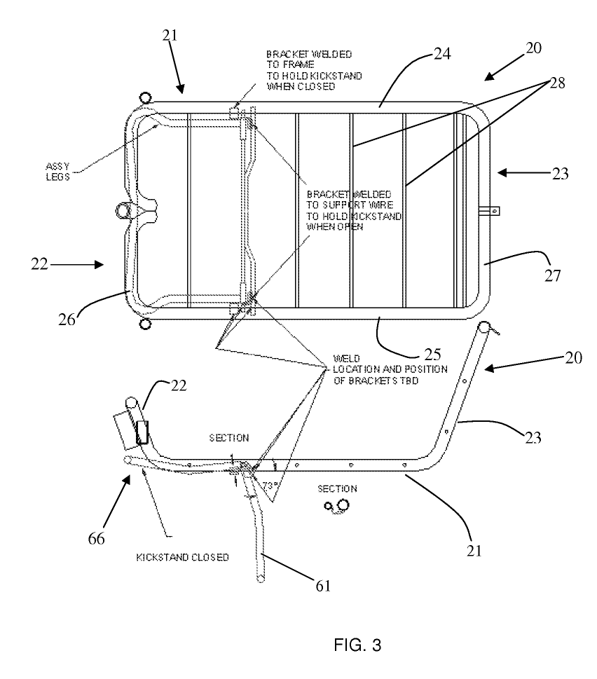

FIG. 1 illustrates bicycle wheel 1 and trailer 2 having the connecting means 3 and 4. FIG. 2 illustrates the main parts of the trailer 2, and FIG. 3 illustrates the top and the side views of the trailer. The main parts of the present trailer are a fork 10 connecting the bicycle wheel 1 to the trailer 2, the main trailer frame 20, a trailer wheel 40, a pair of handles 50. The trailer main frame 20 is substantially rectangular, having a bottom section 21, a forwardly upward front extension 22 and a backwardly upward rear extension 23. Trailer main frame 20 comprises of a left frame 24, a right frame 25, a front bar 26 and a back bar 27. The main frame 20 can be constructed from a single tubing bent to the proper shape as shown in FIG. 2. Alternatively, it can be constructed from separate sections. Multiplicity of crossbars 28, shown on FIG. 3, extend across the trailer frame 20 from the left frame 24 to the right frame 25. Also, crossbars 29 extend from the front extension 22 to the rear extension 23.

Trailer 2 has a single wheel 40, having an axle 41, and having two pairs of supporting bars 42 and 43, connecting the wheel to the trailer. Trailer wheel is smaller than the bicycle wheel, preferably 16″ in size. This keeps the trailer closer to the ground and therefore more stable. The two supporting bars 42 are inclined forwards from the wheel axel and extends from the wheel axle 41 to the back bar of the trailer 27, each bar from one side of the wheel. The two supporting bar 43 are substantially longitudinal and extend from the wheel axle 41 to the left 24 and the right 25 frame, respectively, each bar from one side of the wheel. The wheel may have a fender 44 and reflective lights 45.

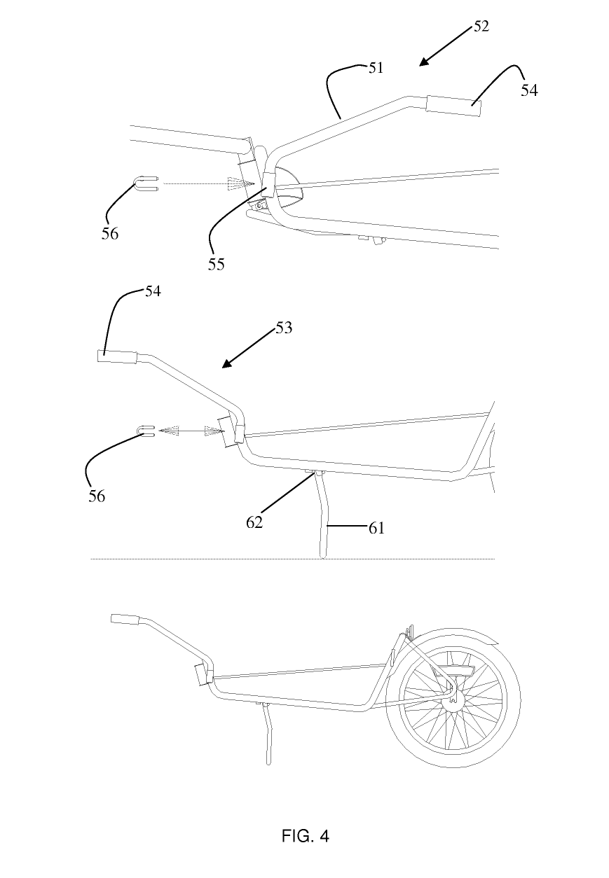

Trailer 2 has two handles, a left and a right handle 51, as illustrated in FIG. 4. These handles can be in closed position 52 or open position 53. The handles are pivotably connected to the forward extension of the trailer frame. The connection mechanism in the present embodiment is a socket 55 that receives one end of the handle. The handles can be locked by a clamp 56. The handles can be moved by first removing the clamp and turning the handle from one position to another position. Handles 51 also have grippers 54. Variety of other locking mechanisms, other than the clamp mechanism, can be used to turn and lock the handles.

Kickstand 61 is pivotably connected to the left 24 and the right 25 frames, respectively. Brackets 62 are welded to the frame to hold the kickstand. Kickstand holds the trailer and the bicycle in the upright position. Kickstand aligns along the trailer frame in the closed position 66, as shown in FIG. 3.

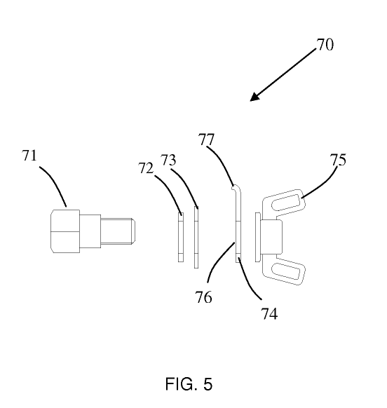

In order to easily connect and disconnect the trailer from a bicycle wheel, a special nut 71, as shown in FIG. 5, is designed. This nut replaces the standard nuts found on a bicycle. Once nut 71 is used, the trailer can be easily connected and disconnected from the wheel. The two nuts on each side of a bicycle rear wheel are replaced with the assembly 70, consisting of a nut 71, steel washer 72, plastic washer 73, axle bracket 74, and wing nut 75. The axle bracket 74 is rectangular having a circular aperture 76 to enter the nut and also having a small bend 77 on it top. This bend prevents the fork to slip off the axle of the wheel, once the wing nut is tightened.

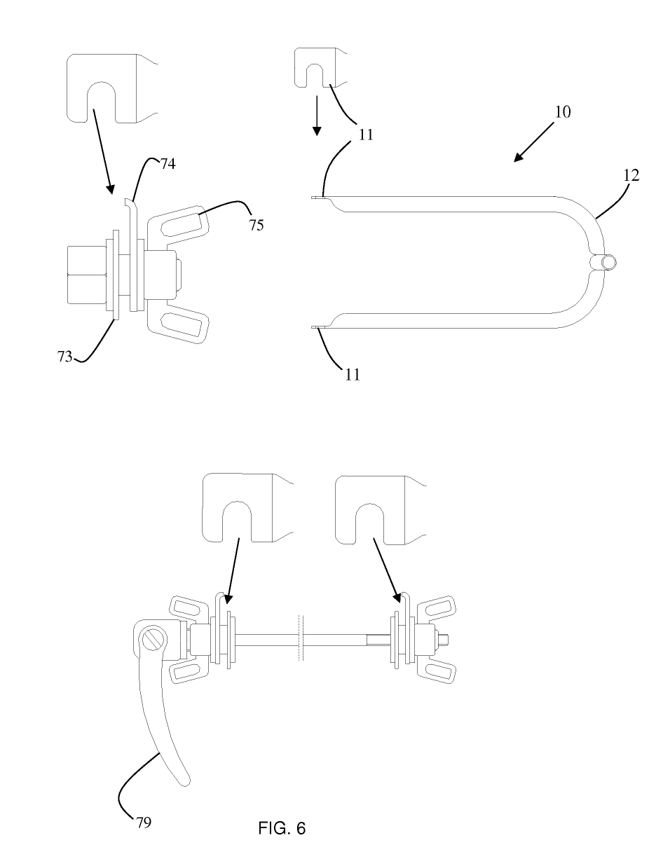

FIG. 6 illustrated fork 10, which is a U shaped tubing having two ends 11 and a substantially flat center 12. Each end having a bracket 11 to receive the axle of the bicycle. Fork 10 is adjusted to fit on the two sides of the wheel. The fork ends 11 should fit between the axle bracket 74 and the plastic washer 73. The fort spacing is adjusted manually to make sure that it sits tight against the plastic washer before the wing nut 75 is tightened. The method of connecting the fork comprises of loosening the wing nut a few turns; positioning the bracket so it firmly grips the top of the fork; and then manually tightening the wing nut. FIG. 6 also illustrated a quick release 79 connection option, that can be used to quickly connect and disconnect the trailer. Once the fork is connected to the bicycle wheel axel, it should be pivot around the axel.

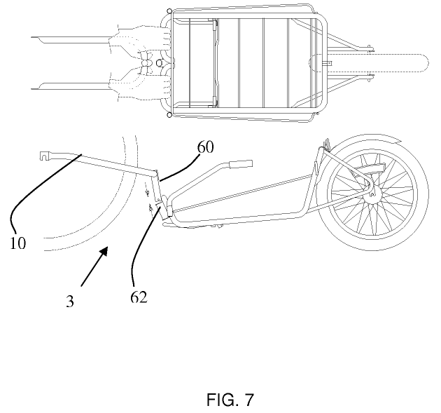

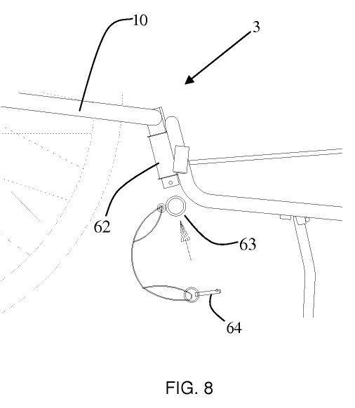

FIGS. 7 and 8, illustrate the connecting mechanism 3 in the present embodiment to connect the trailer 2 to the bicycle wheel 1. Fork 10 comprises of a rear end extension short tube 60. The apertures are provided along the length of the short tube to allow the trailer to connect to different size bicycle wheels. Therefore, the trailer main frame can remain at approximately the same height from the ground, when used in combination with various size bicycle wheels. Extension 60 is inserted into a socket 62 which is fixed on the front bars of the trailer. A ring 63 and the locking pin 64 rotably attach the extension 60 to the trailer 2.

In order to attach the fork to the trailer, the trailer is first positioned inline with the back wheel of the bicycle and the short tube of the fork is inserted into the trailer sleeve, as illustrated in FIG. 7. If the trailer is loaded, it is more convenient to have the trailer kickstand down, and stand over the back wheel of the bicycle, facing the trailer. Then, lifting the back of the wheel by the sides of the fork and pointing the connector tube into the trailer's sleeve. Once the short tube of the fork 60 is inserted into the sleeve 62, a welded ring 63 and detent pin 64 are used to protect the trailer when riding, as illustrated in FIG. 8.

In the installed position, the trailer main frame is slightly angled upwars towards the bicycle, as illustrated in FIG. 1. This allows more of the load to fall on the trailer wheel rather than on the bicycle. Therefore, the bicycle becomes more stable. In the preferred embodiment, when connected to a 28″ bicycle wheel, the back side of the trailer is about 160 mm above the ground, whereas the front of the trailer is 200 mm above the ground. When the trailer is connected to a 26 inch bicycle wheel, the back side is about 154 mm above the ground, whereas the front side is about 186 mm above the ground.

In the preferred embodiment of the present trailer, the front section 22 makes a 15.6 degree counterclockwise angle 48 with the vertical when the trailer is connected to a 26″ wheel bicycle. This angle is 14.3 degrees when the trailer is connected to a 28″ wheel bicycle. In the preferred embodiment of the present trailer, the whole length of the trailer from the axel of the trailer wheel to the axel of the bicycle rear wheel is about 1165 mm.

The center of the gravity of the whole trailer is only 220 or 260 mm above ground when connected to 26″ or 28″ bicycle wheels, respectively.

It is to be understood that the present invention is not limited to the sole embodiment described above, but encompasses any and all embodiments within the scope of the following claims.

What is claimed is:

1. A bicycle trailer and wheelbarrow combination, said trailer comprising:
a. a main frame to hold cargo;
b. a single rear wheel;
c. handle means to convert said trailer into a wheelbarrow;
d. stand means to keep said bicycle and trailer in upright position; and
e. connecting means to connect said trailer to a bicycle.

2. A bicycle trailer and wheelbarrow combination of claim 1 wherein said trailer main frame comprising:
a. a main central section, a back section and a front section;
b. said front section having means to connect to the axle of the rear wheel of a bicycle;
c. said back section having means to connect to the axle of said trailer wheel;
d. multiplicity of crossbars on the main frame to hold cargo; and
e. multiplicity of supporting side arms extending from the back section to the front section to protect the cargo.

3. A bicycle trailer and wheelbarrow combination of claim 1 wherein said trailer main frame comprising:
a. a substantially rectangular frame;
b. said substantially rectangular frame having a left side, a right side, a back side and a front side;
c. said front and back sides are bent upward, forming a cargo holding basket.

4. A bicycle trailer and wheelbarrow combination of claim 1 wherein the center of the gravity of the trailer is 22 to 26 cm from the ground.

5. A bicycle trailer and wheelbarrow combination of claim 1 wherein the distance between the bicycle axel and trailer wheel axel is about 116.5 cm.

6. A bicycle trailer and wheelbarrow combination of claim 1 wherein said rear wheel of the trailer is smaller than a bicycle wheel, preferably 16 inches.

7. A bicycle trailer and wheelbarrow combination of claim 1 wherein said handle means comprising:
a. a pair of wheelbarrow handles;
b. each said handle rotably connected to the left and the right sides of the front section of the trailer frame;
c. said trailer having a pair of handle receiving sockets fixed to said front section of the trailer;
d. said handles rotably inserted into said sockets; and
e. said handles having means to lock the handle in open or closed positions,
whereby said handles are turned and extended forwardly towards the bicycle forming the handles of a wheelbarrow or turned to the closed position towards the trailer when not in use.

8. A bicycle trailer and wheelbarrow combination of claim 1 wherein said stand means comprising a curved tubular kickstand, said kickstand having a spring action when passing a bracket welded on the frame.

9. A bicycle trailer wheelbarrow of claim 1 wherein said means to connect the trailer to the bicycle comprising:
a. a U shaped fork having two ends and middle section;
b. said ends of the fork having bracket to receive bicycle axle;
c. a hitch means to fix said fork on the bicycle wheel;
d. said fork is long enough to extend across the bicycle wheel such that said wheel can freely rotate without contact with the fork; and
e. said fork having a tubing attached to said middle section and extending substantially normal and downwardly to the fork; and
f. said tubing is rotably attached to the trailer forward extension.

10. A bicycle trailer and wheelbarrow combination of claim 9 wherein said hitch means comprising:
a. a bicycle axle nut;
b. said axle nut comprising of a nut having a first and a second cylindrical extensions, said first extension attached to said nut and said second extension attached to the first extension and being smaller than the first extension;
c. a circular steel washer;
d. a circular washer, preferably plastic;
e. a rectangular axle bracket having a bent top and a circular aperture to receive the axle; and
f. a wing nut with a washer,
whereby said fork bracket is positioned between the axle bracket and the circular washer and the wing nut is used tighten the fork onto the bicycle wheel, and whereby said bent on the axle bracket prevents the fork to slip off the bicycle.
